(19) United States
(12) Patent Application Publication
(10) Pub. No.: US 2010/0070769 A1
(43) Pub. Date: Mar. 18, 2010

(54) LOG ACQUISITION SYSTEM, LOG COLLECTION TERMINAL, LOG ACQUISITION TERMINAL, AND LOG ACQUISITION METHOD AND PROGRAM USING THE SAME SYSTEM AND TERMINALS

(76) Inventors: Shigeyoshi Shima, Tokyo (JP); Yukiko Endo, Tokyo (JP)

Correspondence Address: Mr. Jackson Chen, 6535 N. STATE HWY 161, IRVING, TX, 75039, US

(21) Appl. No.: 12/529,448

(22) PCT Filed: Jan. 22, 2008
(86) PCT No.: PCT/JP2008/050777

§ 371 Date: Sep. 1, 2009

(30) Foreign Application Priority Data
Mar. 28, 2007 (JP) 2007-084567

(51) Int. Cl. G06F 21/24; H04L 9/08

(52) U.S. Cl. 713/171; 380/283; 713/189; 380/46

(57) ABSTRACT

In a log acquisition system comprising a log collection terminal for collecting log data and a log acquisition terminal for acquiring the log data collected by the log collection terminal from the log collection terminal, the log collection terminal stores a common key between the log collection terminal and the log acquisition terminal in a hardware security module inherently mounted in the log collection terminal, encrypts the collected log data as encrypted log data using the stored common key, and stores the encrypted log data, and the log acquisition terminal stores the common key in a hardware security module inherently mounted in the log acquisition terminal, acquires the encrypted log data from the log collection terminal, and decrypts the acquired encrypted log data with the common key.

### TECHNICAL FIELD

The present invention relates to a log acquisition system for acquiring a log collected by a terminal, a log collection terminal, a log acquisition terminal, and a log acquisition method and program using such a system and terminals.

### BACKGROUND ART

The number of users carrying cellular phones has been increasing in recent years. Many users think they cannot live without cellular phones. There is no doubt that cellular phones have become one of the daily necessities.

When initially introduced into the market, the cellular phone was quite simple, providing only a verbal communication capability. Subsequently, it has become equipped with various additional functions including packet communications for mails or the like, photographing capability with camera, music playback capability, and GPS (Global Positioning System) for locating the cellular phone.

The cellular phone with these various functions can quickly be contacted and allows its present position to be recognized, i.e., allows the position of the user carrying the cellular phone to be recognized. For these reasons, more parents who are concerned about whereabouts of their children are wanting them to carry cellular phones.

Information that is acquired using the above functions is stored as a log in the cellular phone. For example, a record of incoming and outgoing calls, a record of sent and received mails, and a record of positional information are stored in the cellular phone. Consequently, it is possible to grasp the behavioral pattern of the cellular phone holder by referring to the information that is stored as those logs.

There has been proposed a technology wherein a cellular phone encrypts a communication log thereof and stores the encrypted communication log, and another cellular phone acquires and decrypts the encrypted communication log to refer to the communication log (see, for example, JP-A No. 2005-258855).

However, since the cellular phone holder is able to falsify or delete the log information, the log information suffers a lack of credibility even when it is referred to.

The technology disclosed in JP-A No. 2005-258855 is problematic in that once the user of a cellular phone obtains an encryption key used to encrypt a communication log in the cellular phone and a decryption key used to decrypt the communication log, the user can falsify the communication log on the cellular phone.

### DISCLOSURE OF THE INVENTION

In order to solve the above problems, it is an object of the present invention to provide a log acquisition system, a log collection terminal, and a log acquisition terminal for preventing log information from being falsified and referring to correct log information, and a log acquisition method and program using such a system and terminals.

To achieve the above object, there is provided in accordance with the present invention a log acquisition system including a log collection terminal for collecting log data and a log acquisition terminal for acquiring the log data collected by said log collection terminal from the log collection terminal, wherein

said log collection terminal stores a common key in the log collection terminal and said log acquisition terminal, in a hardware security module inherently installed in said log collection terminal, encrypts the collected log data into encrypted log data with the stored common key, and stores the encrypted log data; and

said log acquisition terminal stores said common key in a hardware security module inherently installed in the log acquisition terminal, acquires the encrypted log data from said log collection terminal, and decrypts the acquired encrypted log data with said common key.

There is also provided a log collection terminal for collecting a log, wherein said log collection terminal stores a common key in the log collection terminal and a log acquisition terminal for acquiring the log data collected by said log collection terminal, in a hardware security module inherently installed in said log collection terminal, and encrypts the collected log data into encrypted log data with the stored common key.

There is also provided a log acquisition terminal for acquiring log data collected by a log collection terminal, wherein said log acquisition terminal stores a common key in said log acquisition terminal and said log collection terminal, in a hardware security module inherently installed in the log acquisition terminal, acquires encrypted log data, which are produced by encrypting said log data, from said log collection terminal, and decrypts the acquired encrypted log data with said common key.

There is also provided a log acquisition method of acquiring log data collected by a log collection terminal with a log acquisition terminal, comprising:

a process wherein said log collection terminal stores a common key in the log collection terminal and said log acquisition terminal, in a hardware security module inherently installed in said log collection terminal;

a process wherein said log acquisition terminal stores said common key in a hardware security module inherently installed in the log acquisition terminal;

a process wherein the hardware security module inherently installed in the log acquisition terminal encrypts the collected log data into encrypted log data with the stored common key;

a process wherein said log acquisition terminal acquires the encrypted log data from said log collection terminal; and

a process wherein the hardware security module inherently installed in the log acquisition terminal decrypts the acquired encrypted log data with said common key.

There is also provided a program for acquiring a collected log by enabling a log collection terminal for collecting a log to perform:

a sequence for storing a common key in the log collection terminal and a log acquisition terminal for acquiring the log data collected by said log collection terminal, in a hardware security module inherently installed in said log collection terminal; and

a sequence for encrypting the collected log data into encrypted log data with the stored common key.

There is also provided a program for enabling a log acquisition terminal for acquiring log data collected by a log collection terminal, to perform:

a sequence for storing a common key in said log acquisition terminal and said log collection terminal, in a hardware security module inherently installed in the log acquisition terminal;

a sequence for acquiring encrypted log data, which are produced by encrypting said log data, from said log collection terminal; and

a sequence for decrypting the acquired encrypted log data with said common key.

According to the present invention, as described above, the log collection terminal for collecting log data stores the common key in the log collection terminal and the log acquisition terminal for acquiring the collected log data, in the hardware security module inherently installed in the log collection terminal, and encrypts the collected log data into the encrypted log data with the common key. The log acquisition terminal stores the common key in the hardware security module inherently installed in the log acquisition terminal, acquires the encrypted log data from the log collection terminal, and decrypts the acquired encrypted log data with the common key. Therefore, log information is prevented from being falsified, and correct log information can be referred to.

### BRIEF DESCRIPTION OF THE DRAWINGS

FIG. 1 is a diagram showing a configuration of a log acquisition system according to the present invention;

FIG. 2 is a diagram showing a configurational example of a user terminal as a log collection terminal shown in FIG. 1;

FIG. 3 is a diagram showing a configurational example of a user terminal as a log acquisition terminal shown in FIG. 1;

FIG. 4 is a sequence diagram illustrative of a process for establishing initial settings (to register keys) between the user terminal as the log collection terminal and the user terminal as the log acquisition terminal, according to a log acquisition method in the log acquisition system shown in FIGS. 1 through 3;

FIG. 5 is a sequence diagram illustrative of a process for collecting a log in the user terminal as the log collection terminal according to the log acquisition method in the log acquisition system shown in FIGS. 1 through 3;

FIG. 6 is a sequence diagram illustrative of a process for verifying a log in the user terminal as the log acquisition terminal according to the log acquisition method in the log acquisition system shown in FIGS. 1 through 3;

FIG. 7 is a diagram showing an example of a data structure stored in a log storage unit shown in FIG. 3;

FIG. 8 is a view showing an example of a screen displayed on a display unit shown in FIG. 3 when log data are recognized as being falsified; and

FIG. 9 is a view showing an example of a screen displayed on the display unit shown in FIG. 3 when log data stored in the log storage unit shown in FIG. 3 are to be referred to.

### BEST MODE FOR CARRYING OUT THE INVENTION

An exemplary embodiment of the present invention will be described below with reference to the drawings.

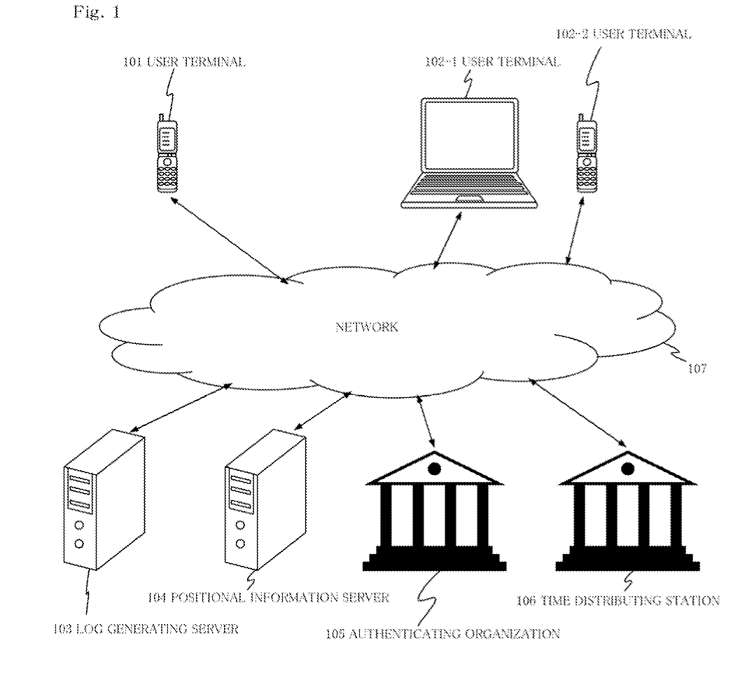

FIG. 1 is a diagram showing a configuration of a log acquisition system according to the present invention.

As shown in FIG. 1, the configuration of the log acquisition system comprises user terminals 101, 102-1, 102-2, log generating server 103, positional information server 104, authenticating organization 105, and time distributing station 106, which are connected by network 107.

User terminal 101 is a log collection terminal whose log information is to be collected. The collected log information cannot be referred to from user terminal 101. Operation of user terminal 101 will be described later. User terminal 101 is a mobile terminal that can be moved.

User terminals 102-1, 102-2 are log acquisition terminals for referring to the log information of user terminal 101. User terminals 102-1, 102-2 may be fixed terminals or mobile terminals that can be moved. Though the number of user terminals 102-1, 102-2 shown in FIG. 1 is two, the number of user terminals is not limited.

Log generating server 103 is a server capable of storing the log information collected by user terminal 101.

Positional information server 104 is a server for providing positional information to user terminal 101.

Authenticating organization 105 is an organization for recognizing persons who have produced an electronic signature.

Time distributing station 106 distributes time information to user terminals 101, 102-1, 102-2.

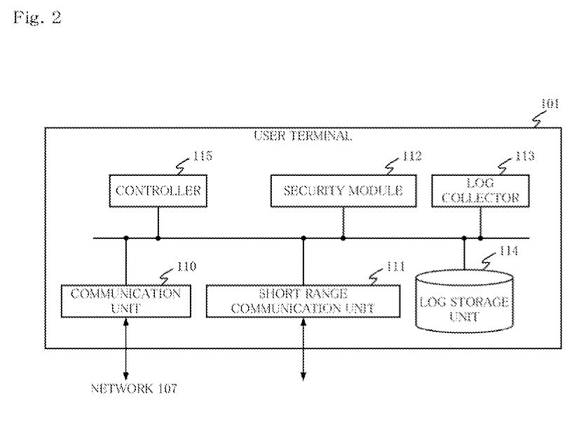

FIG. 2 is a diagram showing a configurational example of user terminal 101 shown in FIG. 1. FIG. 2 shows only those components of user terminal 101 shown in FIG. 1 which have a bearing on the present invention.

As shown in FIG. 1, user terminal 101 shown in FIG. 1 comprises communication unit 110, short range communication unit 111, security module 112, log collector 113, log storage unit 114, and controller 115 for controlling them.

Communication unit 110 communicates with user terminals 102-1, 102-2, log generating server 103, positional information server 104, authenticating organization 105, and time distributing station 106 through network 107.

Short range communication unit 111 sends information to and receives information from user terminals 102-1, 102-2 by way of wireless communications such as short range communications (infrared, Bluetooth, etc.).

Security module 112 is a module for encrypting information. Security module 112 comprises a hardware security module. The hardware security module is a security module that is inherently installed in the hardware of a general computer and cannot be transferred to another computer, and realizes security and privacy. The hardware security module includes a memory for storing an encryption key, a decryption key, etc. The keys stored in the hardware security module cannot be taken out from outside of the hardware security module. If the hardware security module installed in the computer is removed from the computer, then the computer cannot be started. Consequently, when the encryption key, the decryption key, etc. of the user are stored in the hardware security module, the security of those keys and information encrypted by those keys is guaranteed. The hardware security module is generally constructed as a single chip or a combination with peripheral circuits, and may be a TPM (Trusted Platform Module), for example.

Log collector 113 collects log information including a record of incoming and outgoing calls, a record of sent and received mails, a record of accessed URLs, and a record of positional information of user terminal 101.

Log storage unit 114 stores the log information collected by log collector 113.

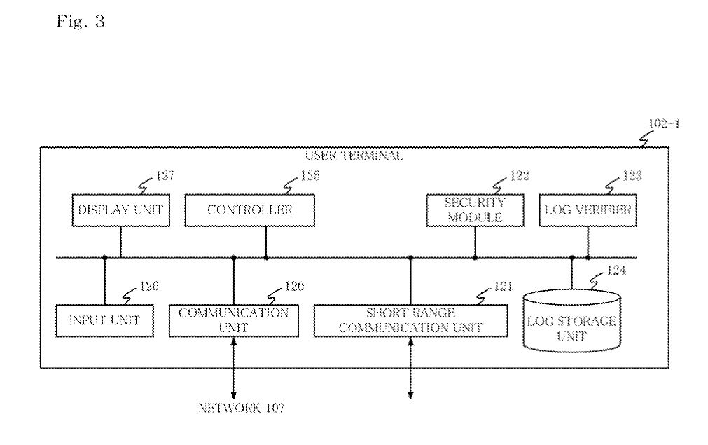

FIG. 3 is a diagram showing a configurational example of user terminal 102-1 shown in FIG. 1. FIG. 3 shows only those components of user terminal 102-1 shown in FIG. 1 which have a bearing on the present invention. User terminal 102-2 shown in FIG. 1 also has the same configuration as that of user terminal 102-1 shown in FIG. 3.

As shown in FIG. 3, user terminal 102-2 shown in FIG. 1 comprises communication unit 120, short range communication unit 121, security module 122, log verifier 123, log storage unit 124, input unit 126, display unit 127, and controller 125 for controlling them.

Communication unit 120 communicates with user terminals 101, 102-2, log generating server 103, positional information server 104, authenticating organization 105, and time distributing station 106 through network 107.

Short range communication unit 121 sends information to and receives information from user terminal 101 by way of wireless communications such as short range communications (infrared, Bluetooth, etc.).

Security module 122 is a module for encrypting information. Security module 122 comprises a hardware security module as with security module 112.

Log verifier 123 verifies whether the log information that has been collected by user terminal 101 and then acquired by user terminal 102-1 has been falsified at user terminal 102-1 or not.

Log storage unit 124 stores log information if log verifier 123 judges that the log information has not been falsified.

Input unit 126 is used by the user to enter information into user terminal 102-1 from outside thereof. Input unit 126 may be a keyboard, a mouse, cellular phone input buttons or touch panel, or the like.

Display unit 127 displays contents entered from input unit 126, log information stored in log storage unit 124, etc. Display unit 127 may comprise a general display for displaying information.

A log acquisition method in the log acquisition system shown in FIGS. 1 through 3 will be described below with reference to sequence diagrams. In the log acquisition method, user terminal 102-1, for example, is used as a log acquisition terminal.

First, a process for establishing initial settings (to register keys) between user terminal 101 and user terminal 102-1 shown in FIG. 1 will be described below.

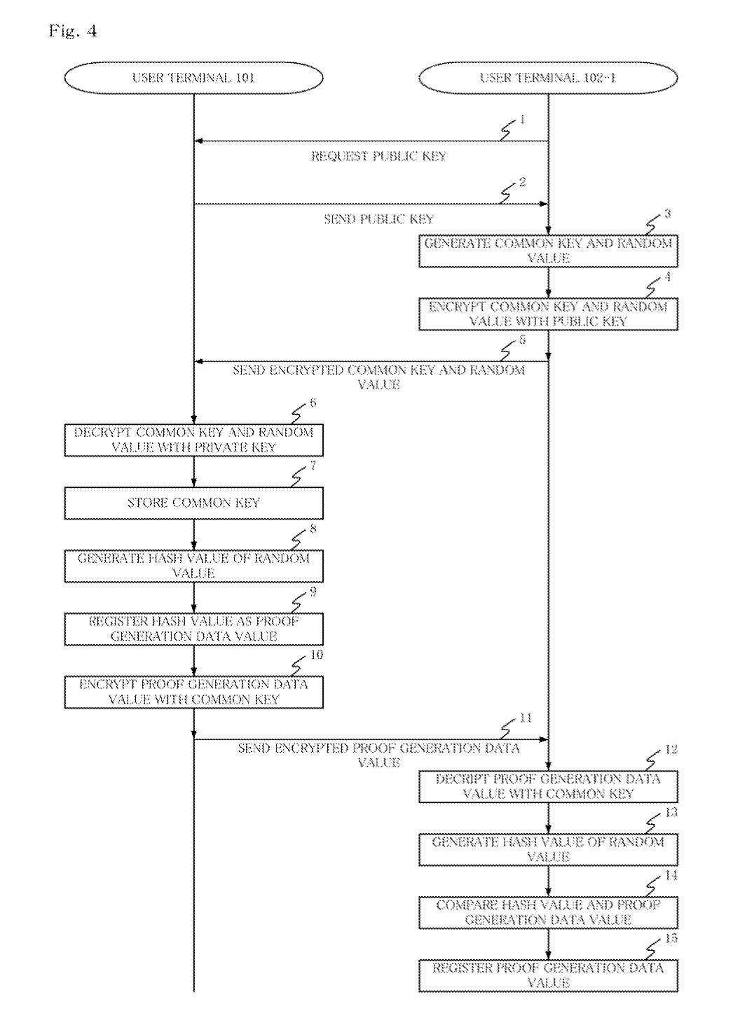

FIG. 4 is a sequence diagram illustrative of the process for establishing initial settings (to register keys) between user terminal 101 and user terminal 102-1, according to the log acquisition method in the log acquisition system shown in FIGS. 1 through 3. Exchanges between user terminal 101 and user terminal 102-1, which will be described with reference to the sequence diagram shown in FIG. 4, take place through network 107.

In step 1, user terminal 102-1 sends a request to user terminal 101 to ask for a public key thereof. In step 2, communication unit 110 of user terminal 101 sends the public key of user terminal 101 to user terminal 102-1 through network 107. The request that user terminal 102-1 sends to user terminal 101 to ask for a public key thereof may be in the form of a signal that is sent and received to recognize that user terminal 102-1 has asked user terminal 101 for a public key thereof. Any format of the signal will not be specified here. Any process of sending the public key will not be specified here either.

When the public key of user terminal 101 sent from user terminal 101 is received by communication unit 120 of user terminal 102-1, security module 122 generates a random value and a common key which will be used in common by user terminal 101 and user terminal 102-1, in step 3.

Then, security module encrypts the common key and the random value with the received public key of user terminal 101 in step 4, and sends the encrypted common key and the encrypted random value from communication unit 120 through network 107 to user terminal 101 in step 5.

The common key and the random value generated in step 3 are stored in the memory of security module 122.

When the common key and the random value sent from user terminal 102-1 are received by communication unit 110 of user terminal 101 through network 107, security module 112 decrypts the common key and the random value with the private key of user terminal 101 in step 6.

The decrypted common key is stored in the memory of security module 112 in step 7.

In step 8, a hash value of the decrypted random value is generated by security module 112. The generated hash value is registered as a proof generation data value in security module 112 in step 9. Specifically, the generated hash value is stored as a proof generation data value in the memory of security module 112.

Thereafter, security module 112 encrypts the registered proof generation data value with the common key stored in the memory of security module 112 in step 10. In step 11, the encrypted proof generation data value is sent from communication unit 110 through network 107 to user terminal 102-1.

When the proof generation data value sent from user terminal 101 is received by communication unit 120 of user terminal 102-1 through network 107, security module 122 decrypts the proof generation data value with the common key in step 12. The common key used to decrypt the proof generation data value is the common key generated in step 3.

In step 13, security module 122 generates a hash value of the random value. Then, security module 122 compares the generated hash value and the proof generation data value decrypted in step 12 with each other in step 14.

If security module 122 judges that the hash value and the proof generation data value agree with each other as a result of the comparison in step 14, then security module 122 registers the proof generation data value in step 15. Specifically, security module 122 stores the proof generation data value in the memory thereof.

A process for collecting a log in user terminal 101 shown in FIG. 1 will be described below.

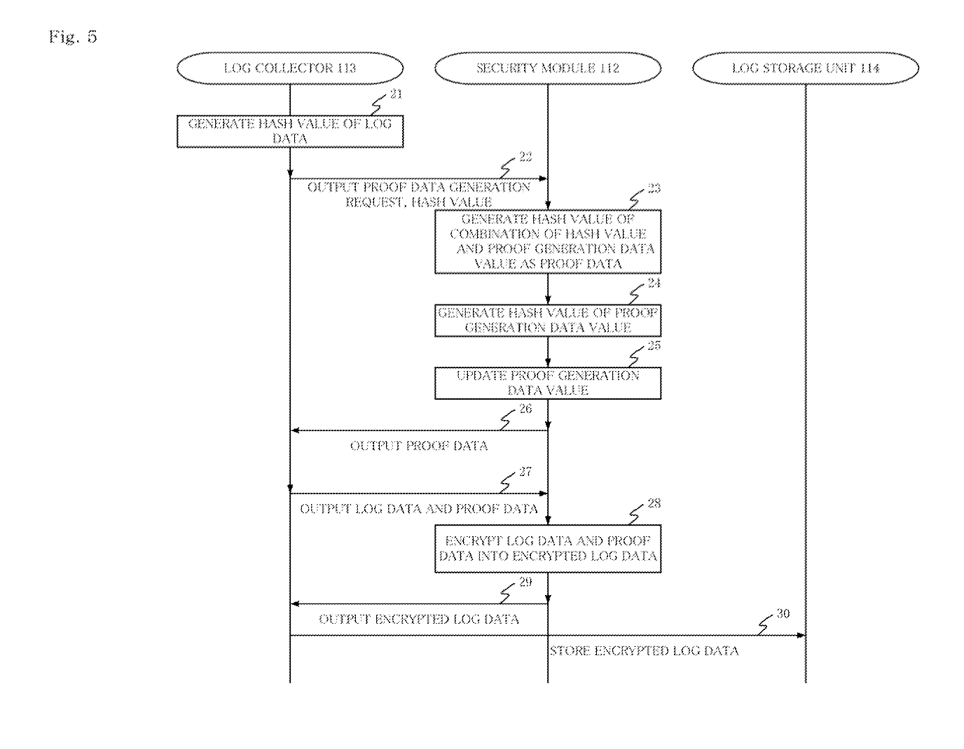

FIG. 5 is a sequence diagram illustrative of the process for collecting a log in user terminal 101 according to the log acquisition method in the log acquisition system shown in FIGS. 1 through 3.

When log collector 113 acquires log data, it generates a hash value of the acquired log data in step 21. The log data represent a record of incoming and outgoing calls, a record of sent and received mails, a record of accessed URLs, and a record of positional information of user terminal 101. The process of acquiring the log data is the same as the conventional process and will not be described below.

When log collector 21 generates the hash value of the log data, it outputs the generated hash value to security module 112 in step 22. At the same time, log collector 113 sends a request to security module 112 to generate proof data. The request may be in the form of a signal that is sent and received to recognize that log collector 113 has requested security module 112 to generate proof data. Any format of the signal will not be defined here.

When requested to generate proof data, security module 112 generates proof data in step 23. The generated proof data represent a hash value generated from a combination of the hash value output from log collector 113 and a proof generation data value registered in advance.

Security module 112 generates a hash value of the proof generation data value in step 24, and updates the present proof generation data value into the generated hash value as a proof generation data value in step 25.

The proof data generated in step 23 are output from security module 112 to log collector 113 in step 26.

When the proof data output from security module 112 are received by log collector 113, log collector 113 outputs the log data and the proof data to security module 112 in step 27.

The log data and the proof data which are received by security module 112 are encrypted by the encryption key of user terminal 102-1 in step 28. User terminal 101 needs to obtain the encryption key of user terminal 102-1 in advance. The common key stored in step 7 is used as the encryption key. Alternatively, the public key of user terminal 102-1 may be used.

The encrypted log data and the encrypted proof data are handled as encrypted log data. In step 29, the encrypted log data are output from security module 112 to log collector 113 in step 29.

In step 30, log collector 113 stores the encrypted log data in log storage unit 114. The encrypted log data may not be stored in log storage unit 114, but may be sent to log generating server 103 shown in FIG. 1 and stored in log generating server 103.

Since the log data are encrypted by the encryption key of user terminal 102-1, the log data cannot be decrypted by user terminal 101, cannot be falsified at user terminal 101, and cannot even be referred to.

A process for verifying a log stored in log storage unit 114 of user terminal 101 with user terminal 102-1 will be described below.

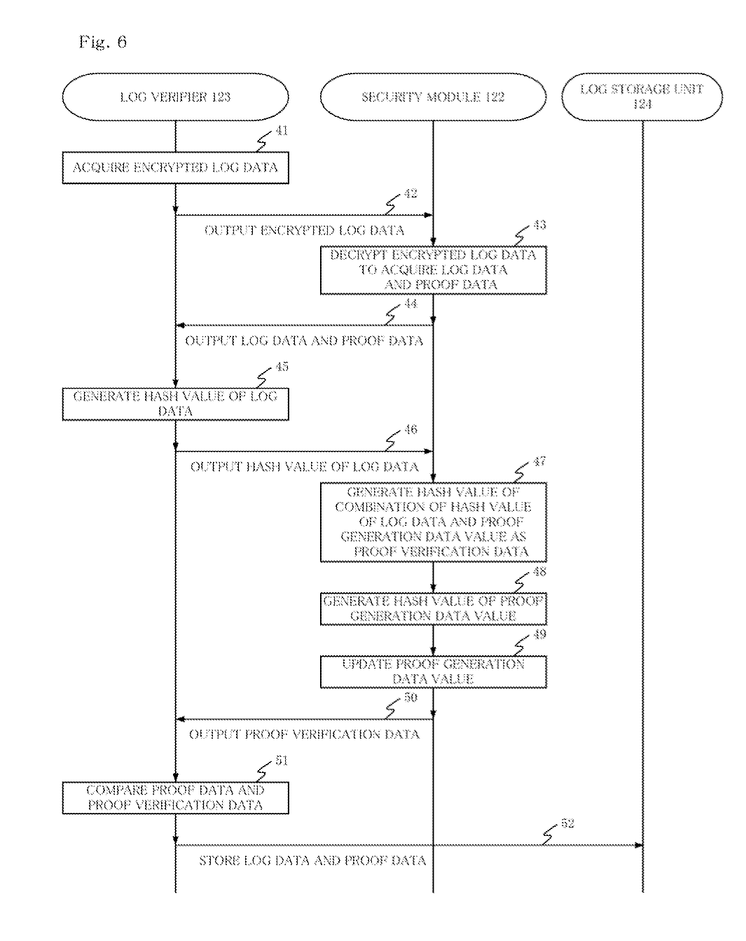

FIG. 6 is a sequence diagram illustrative of the process for verifying a log in user terminal 102-1 according to the log acquisition method in the log acquisition system shown in FIGS. 1 through 3.

The encrypted log data stored in log storage unit 114 of user terminal 101 are acquired by log verifier 123 of user terminal 102-1 through short range communication unit 121 in step 41. Log verifier 123 acquires the encrypted log data by way of wireless communications such as short range communications (infrared, Bluetooth, etc.) between short range communication unit 111 of user terminal 101 and short range communication unit 121 of user terminal 102-1. The wireless communications such as short range communications are of the nature of the background art and will not be described below. If the encrypted log data are stored in log generating server 103, then the encrypted log data are acquired from log generating server 103 through network 107 and communication unit 120.

The encrypted log data acquired by log verifier 123 are output from log verifier 123 to security module 122 in step 42.

When the encrypted log data are received by security module 122, the received encrypted log data are decrypted by the decryption key of user terminal 102-1 in step 43, so that security module 122 acquires log data and proof data. The common key generated in step 3 and stored in security module 122 is used as the decryption key. If the public key of user terminal 102-1 is used as the encryption key in step 28, then the private key of user terminal 102-1 which is paired with the public key used for encryption by user terminal 101 is used as the decryption key.

When security module 122 acquires the log data and the proof data, security module 122 outputs the acquired log data and the acquired proof data to log verifier 123 in step 44.

When log verifier 123 receives the log data, log verifier 123 generates a hash value of the received log data in step 45. The generated hash value is output from log verifier 123 to security module 122 in step 46 for requesting the verification of the proof data.

When security module 122 receives the hash value of the log data, security module 122 generates proof verification data in step 47. The generated proof verification data represent a hash value generated from a combination of the received hash value and a proof generation data value registered in advance.

Security module 122 generates a hash value of the proof generation data value in step 48, and updates the present proof generation data value into the generated hash value as a proof generation data value in step 49.

The proof verification data generated in step 47 are output from security module 122 to log verifier 123 in step 50.

Thereafter, log verifier 123 compares the proof data output from security module 122 in step 44 and the proof verification data output from security module 122 in step 50 with each other in step 51.

If log verifier 123 judges that the proof data and the proof verification data agree with each other, then log verifier 123 stores the proof data and the log data that have been output together with the proof data from the security module into log storage unit 124 in step 52.

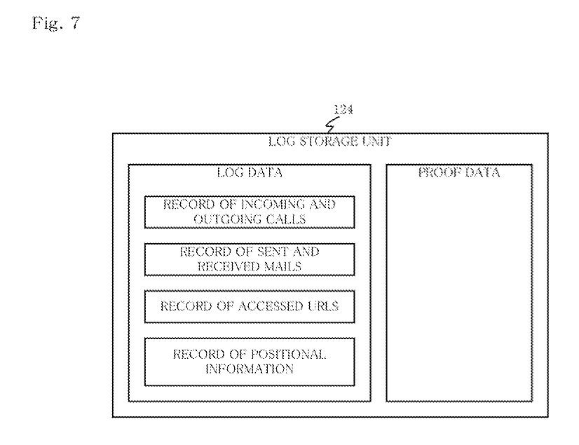

FIG. 7 is a diagram showing an example of a data structure stored in log storage unit 124 shown in FIG. 3.

As shown in FIG. 7, log storage unit 124 shown in FIG. 3 stores log data and proof data. The log data include a record of incoming and outgoing calls, a record of sent and received mails, a record of accessed URLs, and a record of positional information of user terminal 101.

If log verifier 123 judges that the proof data and the proof verification data do not agree with each other, then log verifier 123 recognizes that the log data have been falsified, and does not store the log data and the proof data into log storage unit 124. At this time, display unit 127 may display information indicating that the log data have been falsified.

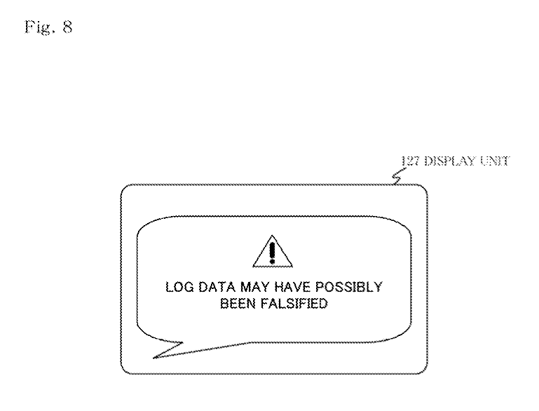

FIG. 8 is a view showing an example of a screen displayed on display unit 127 shown in FIG. 3 when log data are recognized as being falsified.

As shown in FIG. 8, display unit 127 shown in FIG. 3 displays a message “LOG DATA MAY HAVE POSSIBLY BEEN FALSIFIED” or the like. User terminal 102-1 thus can recognize that the log data of user terminal 101 have been falsified at user terminal 101.

Thereafter, the user of user terminal 102-1 can refer to the log data stored in log storage unit 124 by operating input unit 126 of user terminal 102-1.

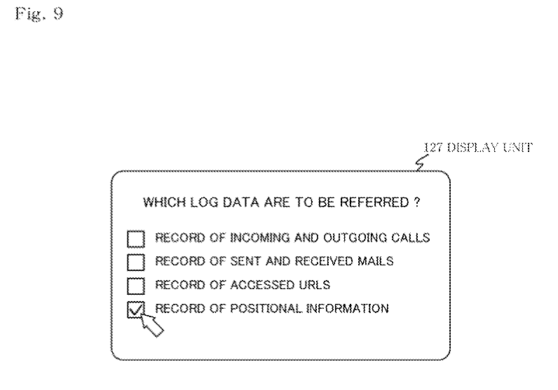

FIG. 9 is a view showing an example of a screen displayed on display unit 127 when log data stored in log storage unit 124 are to be referred to.

In order for the user to refer to log data stored in log storage unit 124, display unit 127 displays a screen for selecting which one of the log data is to be referred to, as shown in FIG. 9. For example, in order for the user to select a record of incoming and outgoing calls, a record of sent and received mails, a record of accessed URLs, and a record of positional information, check boxes are added to the respective records. When the user selects the check box of a desired record with a cursor (arrow), the record is displayed. Alternatively, a desired record may be displayed when it is selected with a pull-down menu. Any selecting method will not be specified here.

Since the proof generation data are updated each time log data and proof data are generated, if no proof data correspond to the proof generation data when a log is verified in user terminal 102-1, then it is detected that proof data have been erased in user terminal 101.

The encryption key has been described as being transferred through network 107. However, the encryption key may be transferred using a short range communicating function.

According to the present invention, a program for realizing the above functions may be recorded in a recording medium which can be read by a computer, and the program recorded in the recording medium may be read and executed by the computer. The recording medium which can be read by a computer may be a removable recording medium such as a floppy disk (registered trademark), a magnetooptical disk, a DVD, a CD, or the like, or an HDD or the like incorporated in the computer. The program recorded in the recording medium is read by controller 115 of user terminal 101 and controller 125 of user terminal 102-1, each corresponding to a computer according to the present invention, and controllers 115, 125 control the terminals to perform the same processes as those described above.

In the log acquisition system according to the present invention, said log collection terminal may generate a hash value of a random value sent from said log acquisition terminal as a proof generation data value, store the proof generation data value in the hardware security module inherently installed in the log collection terminal, send the proof generation data value to said log acquisition terminal, generate a hash value of a combination of a hash value of the collected log data and said proof generation data value as proof data, update said proof generation data value into a hash value of the proof generation data value, and encrypt said log data and said proof data into the encrypted log data with said common key, and the log acquisition terminal may generate a random value, send the random value to said log collection terminal, and if a hash value of the random value and the proof generation data value sent from said log collection terminal agree with each other, store the proof generation data value in the hardware security module inherently installed in the log acquisition terminal, acquire said encrypted log data from said log collection terminal, decrypt said encrypted log data with said common key, thereby acquiring said log data and said proof data, generate a hash value of the acquired log data, generate a hash value of a combination of the hash value and the proof generation data value stored in the hardware security module inherently installed in the log acquisition terminal, as proof verification data, update the proof generation data value stored in the hardware security module inherently installed in the log acquisition terminal into a hash value of the proof generation data value, and if said proof data and said proof verification data agree with each other, store said log data and said proof data.

The log collection terminal may comprise a log collector for collecting said log data and generating a hash value of the collected log data, and a log storage unit for storing said encrypted log data. The hardware security module inherently installed in said log collection terminal may generate and store a hash value of the random value sent from said log acquisition terminal, generate a hash value of a combination of the hash value of the log data collected by said log collector and said proof generation data value as proof data, update said proof generation data value into a hash value of said proof generation data value, and encrypt said log data and said proof data into encrypted log data with said common key. The log acquisition terminal may comprise a log verifier for acquiring said encrypted log data from said log collection terminal, generating a hash value of the acquired log data, and comparing said proof data and said proof verification data with each other, and a log storage unit for storing said log data and said proof data if said proof data and said proof verification data agree with each other. The hardware security module inherently installed in the log acquisition terminal may generate a random value, and if a hash value of the random value and the proof generation data value sent from said log collection terminal agree with each other, store the proof generation data value, decrypt said encrypted log data with said common key, thereby acquiring said log data and said proof data, generate a hash value of a combination of the hash value generated by said log verifier and the proof generation data value stored in the hardware security module inherently installed in the log acquisition terminal, as proof verification data, and update the proof generation data value stored in the hardware security module inherently installed in the log acquisition terminal into a hash value of the proof generation data value.

If the proof data and said proof verification data do not agree with each other, said log acquisition terminal may display a message to that effect.

The log acquisition terminal may acquire said encrypted log data from said log collection terminal by way of short range wireless communications.

The hardware security module inherently installed in said log collection terminal may comprise a TPM.

The hardware security module inherently installed in said log acquisition terminal may comprise a TPM.

As described above, the log acquisition method according to the present invention may comprise a process wherein the hardware security module inherently installed in the log acquisition terminal generates a random value, a process wherein said log acquisition terminal sends said random value to said log acquisition terminal, a process wherein the hardware security module inherently installed in said log collection terminal generates a hash value of the random value sent from said log acquisition terminal as a proof generation data value, a process wherein said log collection terminal stores said proof generation data value in the hardware security module inherently installed in the log collection terminal, a process wherein said log collection terminal sends said proof generation data value to said log acquisition terminal, a process wherein the hardware security module inherently installed in the log acquisition terminal compares said random value and the proof generation data value sent from said log collection terminal with each other, a process wherein if the hash value of said random value and the proof generation data value sent from said log collection terminal agree with each other, said log acquisition terminal stores the proof generation data value in the hardware security module inherently installed in the log acquisition terminal, a process wherein the hardware security module inherently installed in the log collection terminal generates a hash value of a combination of a hash value of the collected log data and said proof generation data value as proof data, a process wherein the hardware security module inherently installed in the log collection terminal updates said proof generation data value into a hash value of the proof generation data value, a process wherein the hardware security module inherently installed in the log collection terminal encrypts said log data and said proof data into encrypted log data with said common key, a process wherein said log acquisition terminal acquires said encrypted log data from said log collection terminal, a process wherein the hardware security module inherently installed in the log acquisition terminal decrypts said encrypted log data with said common key, thereby acquiring said log data and said proof data, a process wherein said log acquisition terminal generates a hash value of the acquired log data, a process wherein the hardware security module inherently installed in the log acquisition terminal generates a hash value of a combination of the hash value and the proof generation data value stored in the hardware security module inherently installed in the log acquisition terminal, as proof verification data, a process wherein the hardware security module inherently installed in the log acquisition terminal updates the proof generation data value stored in the hardware security module inherently installed in the log acquisition terminal into a hash value of the proof generation data value, a process wherein said log acquisition terminal compares said proof data and said proof verification data with each other, and a process wherein if said proof data and said proof verification data agree with each other, said log acquisition terminal stores said log data and said proof data.

The log acquisition method may comprise a process wherein if said proof data and said proof verification data do not agree with each other, said log acquisition terminal displays a message to that effect.

The log acquisition method may comprise a process wherein said log acquisition terminal acquires said encrypted log data from said log collection terminal by way of short range wireless communications.

The log collection terminal may be enabled to perform a sequence for generating a hash value of a random value sent from said log acquisition terminal as a proof generation data value, a sequence for storing the proof generation data value in said hardware security module, a sequence for sending the proof generation data value to said log acquisition terminal, a sequence for generating a hash value of a combination of a hash value of the collected log data and said proof generation data value as proof data, a sequence for updating said proof generation data value into a hash value of the proof generation data value, and a sequence for encrypting said log data and said proof data into the encrypted log data with said common key.

The log acquisition terminal may be enabled to perform a sequence for generating a random value, a sequence for sending the random value to said log collection terminal, a sequence for, if a hash value of the random value and proof generation data value sent from said log collection terminal agree with each other, storing the proof generation data value in said hardware security module, a sequence for acquiring said encrypted log data from said log collection terminal, a sequence for decrypting said encrypted log data with said common key, thereby acquiring said log data and proof data generated by said log collection terminal, a sequence for generating a hash value of the acquired log data, a sequence for generating a hash value of a combination of said hash value and the proof generation data value stored in said hardware security module, as proof verification data a sequence for updating the proof generation data value stored in said hardware security module into a hash value of the proof generation data value, and a sequence for, if said proof data and said proof verification data agree with each other, storing said log data and said proof data.

The log acquisition terminal may be enabled to perform a sequence for, if said proof data and said proof verification data do not agree with each other, displaying a message to that effect.

The present invention has been described above in reference to the exemplary embodiment thereof. However, the present invention is not limited to the above exemplary embodiment. Various changes that can be understood by those skilled in the art can be made in the configurations and details of the present invention within the scope of the present invention.

The present application claims priority based on Japanese patent application No. 2007-084567 filed on Mar. 28, 2007, and incorporates herein the disclosure thereof in its entirety by reference.

1-26. (canceled)

27. A log acquisition system including a log collection terminal for collecting log data and a log acquisition terminal for acquiring the log data collected by said log collection terminal from the log collection terminal, wherein
said log collection terminal stores a common key in the log collection terminal and said log acquisition terminal, in a hardware security module inherently installed in said log collection terminal, generates a hash value of a random value sent from said log acquisition terminal as a proof generation data value, stores the proof generation data value in the hardware security module inherently installed in the log collection terminal, sends the proof generation data value to said log acquisition terminal, generates a hash value of a combination of a hash value of the collected log data and said proof generation data value as proof data, updates said proof generation data value into a hash value of the proof generation data value, and encrypts said log data and said proof data into encrypted log data with said common key; and
said log acquisition terminal stores said common key in a hardware security module inherently installed in the log acquisition terminal, generates a random value, sends the random value to said log collection terminal, and if a hash value of the random value and the proof generation data value sent from said log collection terminal agree with each other, stores the proof generation data value in the hardware security module inherently installed in the log acquisition terminal, acquires said encrypted log data from said log collection terminal, decrypts said encrypted log data with said common key, thereby acquiring said log data and said proof data, generates a hash value of the acquired log data, generates a hash value of a combination of the hash value and the proof generation data value stored in the hardware security module inherently installed in the log acquisition terminal, as proof verification data, updates the proof generation data value stored in the hardware security module inherently installed in the log acquisition terminal into a hash value of the proof generation data value, and if said proof data and said proof verification data agree with each other, stores said log data and said proof data.

28. A log acquisition system according to claim 27, wherein said log collection terminal comprises:
a log collector for collecting said log data and generating a hash value of the collected log data; and
a log storage unit for storing said encrypted log data;
wherein the hardware security module inherently installed in said log collection terminal generates and stores a hash value of the random value sent from said log acquisition terminal, generates a hash value of a combination of the hash value of the log data collected by said log collector and said proof generation data value as proof data, updates said proof generation data value into a hash value of said proof generation data value, and encrypts said log data and said proof data into encrypted log data with said common key;
wherein said log acquisition terminal comprises:
a log verifier for acquiring said encrypted log data from said log collection terminal, generating a hash value of the acquired log data, and comparing said proof data and said proof verification data with each other; and
a log storage unit for storing said log data and said proof data if said proof data and said proof verification data agree with each other; and
wherein the hardware security module inherently installed in the log acquisition terminal generates a random value, and if a hash value of the random value and the proof generation data value sent from said log collection terminal agree with each other, stores the proof generation data value, decrypts said encrypted log data with said common key, thereby acquiring said log data and said proof data, generates a hash value of a combination of the hash value generated by said log verifier and the proof generation data value stored in the hardware security module inherently installed in the log acquisition terminal, as proof verification data, and updates the proof generation data value stored in the hardware security module inherently installed in the log acquisition terminal into a hash value of the proof generation data value.

29. A log acquisition system according to claim 27, wherein if said proof data and said proof verification data do not agree with each other, said log acquisition terminal displays a message to that effect.

30. A log collection terminal for collecting a log, wherein said log collection terminal stores a common key in the log collection terminal and a log acquisition terminal for acquiring the log data collected by said log collection terminal, in a hardware security module inherently installed in said log collection terminal, generates a hash value of a random value sent from said log acquisition terminal as a proof generation data value, stores the proof generation data value in said hardware security module, sends the proof generation data value to said log acquisition terminal, generates a hash value of a combination of a hash value of the collected log data and said proof generation data value as proof data, updates said proof generation data value into a hash value of the proof generation data value, and encrypts said log data and said proof data into encrypted log data with said common key.

31. A log collection terminal according to claim 30, wherein said log collection terminal comprises:
a log collector for collecting said log data and generating a hash value of the collected log data; and
a log storage unit for storing said encrypted log data;
wherein said hardware security module generates and stores a hash value of the random value sent from said log acquisition terminal, generates a hash value of a combination of the hash value of the log data collected by said log collector and said proof generation data value as proof data, updates said proof generation data value into a hash value of said proof generation data value, and encrypts said log data and said proof data into encrypted log data with said common key.

32. A log acquisition terminal for acquiring log data collected by a log collection terminal, wherein said log acquisition terminal stores a common key in said log acquisition terminal and said log collection terminal, in a hardware security module inherently installed in the log acquisition terminal, generates a random value, sends the random value to said log collection terminal, and if a hash value of the random value and proof generation data value sent from said log collection terminal agree with each other, stores the proof generation data value in said hardware security module, acquires encrypted log data, which are produced by encrypting said log data, from said log collection terminal, decrypts said encrypted log data with said common key, thereby acquiring said log data and proof data generated by said log collection terminal, generates a hash value of the acquired log data, generates a hash value of a combination of the hash value and the proof generation data value stored in said hardware security module, as proof verification data, updates the proof generation data value stored in said hardware security module into a hash value of the proof generation data value, and if said proof data and said proof verification data agree with each other, stores said log data and said proof data.

33. A log acquisition terminal according to claim 32, wherein said log acquisition terminal comprises:
a log verifier for acquiring said encrypted log data from said log collection terminal, generating a hash value of the acquired log data, and comparing said proof data and said proof verification data with each other; and
a log storage unit for storing said log data and said proof data if said proof data and said proof verification data agree with each other; and
wherein said hardware security module generates a random value, and if a hash value of the random value and the proof generation data value sent from said log collection terminal agree with each other, stores the proof generation data value, decrypts said encrypted log data with said common key, thereby acquiring said log data and said proof data, generates a hash value of a combination of the hash value generated by said log verifier and the proof generation data value stored in said hardware security module, as proof verification data, and updates the proof generation data value stored in said hardware security module into a hash value of the proof generation data value.

34. A log acquisition terminal according to claim 32, wherein if said proof data and said proof verification data do not agree with each other, said log acquisition terminal displays a message to that effect.

35. A log acquisition method of acquiring log data collected by a log collection terminal with a log acquisition terminal, comprising:
a process wherein said log collection terminal stores a common key in the log collection terminal and said log acquisition terminal, in a hardware security module inherently installed in said log collection terminal;
a process wherein said log acquisition terminal stores said common key in a hardware security module inherently installed in the log acquisition terminal;
a process wherein the hardware security module inherently installed in the log acquisition terminal generates a random value;
a process wherein said log acquisition terminal sends said random value to said log acquisition terminal;
a process wherein the hardware security module inherently installed in said log collection terminal generates a hash value of the random value sent from said log acquisition terminal as a proof generation data value;
a process wherein said log collection terminal stores said proof generation data value in the hardware security module inherently installed in the log collection terminal;
a process wherein said log collection terminal sends said proof generation data value to said log acquisition terminal;
a process wherein the hardware security module inherently installed in the log acquisition terminal compares said random value and the proof generation data value sent from said log collection terminal with each other;
a process wherein if the hash value of said random value and the proof generation data value sent from said log collection terminal agree with each other, said log acquisition terminal stores the proof generation data value in the hardware security module inherently installed in the log acquisition terminal;
a process wherein the hardware security module inherently installed in the log collection terminal generates a hash value of a combination of a hash value of the collected log data and said proof generation data value as proof data;
a process wherein the hardware security module inherently installed in the log collection terminal updates said proof generation data value into a hash value of the proof generation data value;
a process wherein the hardware security module inherently installed in the log collection terminal encrypts said log data and said proof data into encrypted log data with said common key;
a process wherein said log acquisition terminal acquires said encrypted log data from said log collection terminal;
a process wherein the hardware security module inherently installed in the log acquisition terminal decrypts said encrypted log data with said common key, thereby acquiring said log data and said proof data;
a process wherein said log acquisition terminal generates a hash value of the acquired log data;
a process wherein the hardware security module inherently installed in the log acquisition terminal generates a hash value of a combination of the hash value and the proof generation data value stored in the hardware security module inherently installed in the log acquisition terminal, as proof verification data;
a process wherein the hardware security module inherently installed in the log acquisition terminal updates the proof generation data value stored in the hardware security module inherently installed in the log acquisition terminal into a hash value of the proof generation data value;
a process wherein said log acquisition terminal compares said proof data and said proof verification data with each other; and
a process wherein if said proof data and said proof verification data agree with each other, said log acquisition terminal stores said log data and said proof data.

36. A log acquisition method according to claim 35, comprising:
a process wherein if said proof data and said proof verification data do not agree with each other, said log acquisition terminal displays a message to that effect.

37. A recording medium storing a program for enabling a log collection terminal for collecting a log to perform:
a sequence for storing a common key in the log collection terminal and a log acquisition terminal for acquiring the log data collected by said log collection terminal, in a hardware security module inherently installed in said log collection terminal;
a sequence for generating a hash value of a random value sent from said log acquisition terminal as a proof generation data value;
a sequence for storing the proof generation data value in said hardware security module;
a sequence for sending the proof generation data value to said log acquisition terminal;
a sequence for generating a hash value of a combination of a hash value of the collected log data and said proof generation data value as proof data;
a sequence for updating said proof generation data value into a hash value of the proof generation data value; and
a sequence for encrypting said log data and said proof data into the encrypted log data with said common key.

38. A recording medium storing a program for enabling a log acquisition terminal for acquiring log data collected by a log collection terminal, to perform:
a sequence for storing a common key in said log acquisition terminal and said log collection terminal, in a hardware security module inherently installed in the log acquisition terminal;
a sequence for generating a random value;
a sequence for sending the random value to said log collection terminal;
a sequence for, if a hash value of the random value and proof generation data value sent from said log collection terminal agree with each other, storing the proof generation data value in said hardware security module;
a sequence for acquiring encrypted log data, which are produced by encrypting said log data, from said log collection terminal;
a sequence for decrypting said encrypted log data with said common key, thereby acquiring said log data and proof data generated by said log collection terminal;
a sequence for generating a hash value of the acquired log data;
a sequence for generating a hash value of a combination of said hash value and the proof generation data value stored in said hardware security module, as proof verification data;
a sequence for updating the proof generation data value stored in said hardware security module into a hash value of the proof generation data value; and
a sequence for, if said proof data and said proof verification data agree with each other, storing said log data and said proof data.

39. A recording medium according to claim 38, storing a program for enabling the log acquisition terminal to perform:
a sequence for, if said proof data and said proof verification data do not agree with each other, displaying a message to that effect.

40. A log collection terminal for collecting a log, wherein said log collection terminal generates a hash value as a proof generation data value using a random value sent from a log acquisition terminal for acquiring log data collected by said log collection terminal, and repeats an operation for generating a hash value as proof data from a hash value of the collected log data and said proof generation data value, an operation for updating said proof generation data value into said hash value, and an operation for sending said log data and said proof data to said log acquisition terminal.

41. A log acquisition terminal for acquiring log data collected by a log collection terminal, wherein said log acquisition terminal performs an operation for generating a random value, an operation for sending the random value to a log collection terminal according to claim 40, an operation for generating a hash value as a proof generation data value using said random value, an operation for receiving said log data and said proof data sent from a log collection terminal according to claim 40, an operation for verifying whether the generated log proof generation data and the received log proof generation data agree with each other or not, with a hash value generated as proof data from said proof data and said proof generation data sent from a log collection terminal according to claim 40, an operation for, if the generated log proof generation data and the received log proof generation data agree with each other, accepting said log data as proper log data, and an operation for updating said proof generation data value into said hash value, and repeats said operation for receiving, said operation for verifying, said operation for accepting, and said operation for updating.

42. A log collection method of generating a hash value as a proof generation data value using a random value sent from a log acquisition terminal for acquiring log data collected by said log collection terminal, and repeating an operation for generating a hash value as proof data from a hash value of the collected log data and said proof generation data value, an operation for updating said proof generation data value into said hash value, and an operation for sending said log data and said proof data to said log acquisition terminal.

43. A log collection method of performing an operation for generating a random value, an operation for sending the random value to a log collection terminal which carries out a log collection method according to claim 42, an operation for generating a hash value as a proof generation data value using said random value, an operation for receiving said log data and said proof data sent by a log collection method according to claim 42, an operation for verifying whether the generated log proof generation data and the received log proof generation data agree with each other or not, with a hash value generated as proof data from said proof data and said proof generation data sent by a log collection method according to claim 42, an operation for, if the generated log proof generation data and the received log proof generation data agree with each other, accepting said log data as proper log data, and an operation for updating said proof generation data value into said hash value, and repeating said operation for receiving, said operation for verifying, said operation for accepting, and said operation for updating.

44. A recording medium storing a program for enabling a log collection terminal for collecting a log to perform:
a sequence for generating a hash value as a proof generation data value using a random value sent from a log acquisition terminal for acquiring log data collected by said log collection terminal; and
a sequence for repeating an operation for generating a hash value as proof data from a hash value of the collected log data and said proof generation data value, an operation for updating said proof generation data value into said hash value, and an operation for sending said log data and said proof data to said log acquisition terminal.

45. A recording medium storing a program for enabling log acquisition terminal for acquiring log data collected by a log collection terminal, to perform:
a sequence for generating a random value and sending the random value to a log collection terminal which execute a program according to claim 44;
a sequence for generating a hash value as a proof generation data value using said random value;
a sequence for receiving said log data and said proof data sent from a log collection terminal for collecting a log, wherein said log collection terminal generates a hash value as a proof generation data value using a random value sent from a log acquisition terminal for acquiring log data collected by said log collection terminal, and repeats an operation for generating a hash value as proof data from a hash value of the collected log data and said proof generation data value, an operation for updating said proof generation data value into said hash value, and an operation for sending said log data and said proof data to said log acquisition terminal, and verifying whether the generated log proof generation data and the received log proof generation data agree with each other or not, with a hash value generated as proof data from said proof data and said proof generation data value sent from a log collection terminal for collecting a log, wherein said log collection terminal generates a hash value as a proof generation data value using a random value sent from a log acquisition terminal for acquiring log data collected by said log collection terminal, and repeats an operation for generating a hash value as proof data from a hash value of the collected log data and said proof generation data value, an operation for updating said proof generation data value into said hash value, and an operation for sending said log data and said proof data to said log acquisition terminal;
a sequence for, if the generated log proof generation data and the received log proof generation data agree with each other as a result of the verification, accepting said log data as proper log data;
a sequence for updating said proof generation data value into said hash value; and
a sequence for repeating the operation for receiving, the operation for verifying, the operation for accepting, and the operation for updating.
